(19) United States
(12) Patent Application Publication
(10) Pub. No.: US 2003/0134064 A1
(43) Pub. Date: Jul. 17, 2003

(54) Package of solid chlorinated polyolefin modified with carboxylic acid anhydrideand method of storing the solid

(76) Inventors: Keiji Urata, Tokyo (JP); Hideaki Mitsui, Iwakuni-shi (JP); Takayuki Hirose, Iwakuni-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/130,275

(22) PCT Filed: Sep. 13, 2001
(86) PCT No.: PCT/JP01/07940

(51) Int. Cl. B32B 1/02

(52) U.S. Cl. 428/35.7

(57) ABSTRACT

The invention provides a package of solid material of carboxylic anhydride-modified chlorinated polyolefin to be used for a binder resin for paint or primer that aims at the protection or beautiful ornament of polyolefinic resins, capable of suppressing the changes in physical properties after storing for a long term, and a method of preserving said solid material.

A package of solid material of carboxylic anhydride-modified chlorinated polyolefin, comprising said solid material of carboxylic anhydride-modified chlorinated polyolefin wrapped with a film with the value of water vapor transmission rate measured according to ASTM D895 (“Standard Test Method Water Vapor Permeability of Packages”) (measuring conditions: temperature 37.8±1.1° C., relative humidity 90±2%) of 1.5 g/m²·24 hr or lower, and a method of preserving said solid material.

### TECHNICAL FIELD

The present invention relates to a package of solid material of carboxylic anhydride-modified chlorinated polyolefin to be used as a binder resin for paint or primer that aims at the protection or beautiful ornament of polyolefinic resins, for example, polypropylene, polyethylene, ethylene-propylene copolymer, ethylene-propylene-diene copolymer, etc., and a method of preserving said solid material.

### BACKGROUND TECHNOLOGIES

Because of low price and many excellent properties such as moldability, chemical resistance, heat resistance, water resistance and good electrical characteristics, polyolefinic resins are used widely as industrial materials and one of materials that the growth of demand is most expected in future.

Different from synthetic resins with polarity such as poly-urethane resin, polyamide resin, acrylic resin and polyester resin, however, polyolefinic resin is nonpolar and crystalline, hence it has drawbacks of difficult paintability and adhesion.

For the paintability and adhesion of polyolefinic resin with such difficulty in adherence, chlorinated polyolefin with strong adherence to polyolefinic resin is used in many times so far as a binder resin, and, above all, low-chlorinated polypropylene or low-chlorinated propylene-α-olefin copolymer with chlorine content of 5 to 50% by weight graft copolymerized with carboxylic anhydride (carboxylic anhydride-modified chlorinated polyolefin) is proposed as a painting primer or coating binder resin for polyolefinic moldings in Japanese Patent Publication Nos. Sho 63-50381 and Sho 63-36624, Japanese Unexamined Patent Publication Nos. Sho 57-36128, Sho 59-166534 and Hei 11-181193, Japanese Patent Application No. Hei 11-255662, etc.

Usually, the carboxylic anhydride-modified chlorinated polyolefin is stored or transported by packaging in an appropriate bag in the shape of strand-cut good or pellet good. However, the carboxylic anhydride causes ring opening with the moisture in atmosphere during storage thereof, resulting in increased solution viscosity when dissolving into solvents such as toluene and xylene, which differs significantly from the solution viscosity before ring opening of carboxylic anhydride, hence it could not necessarily be said that it was suitable as abinder resin after storage for a long term.

Furthermore, also in the aspect of physical properties, it was difficult to avoid a decrease in part of the physical properties by ring opening of carboxylic anhydride. For example, the gasohol resistance being a criterion of solvent resistance, that is, the stability of coated film against gasoline/alcohol mixed solution (gasohol) with lower alcohol such as methanol or ethanol added to regular gasoline decreased clearly with ring opening of carboxylic anhydride, thus causing the swelling and peeling-off of coated film.

For suppressing the ring opening of carboxylic anhydride with the moisture in atmosphere, commonly, a method of tightly sealing and keeping in a bag of kraft paper or bag of plastics represented by polyethylene and polypropylene is adopted, but, when keeping for a long term, carboxylic anhydride gradually caused the ring-opening reaction with water to bring about decreased quality. In particular, when exporting the solid material of carboxylic anhydride-modified chlorinated polyolefin, it is preserved for a long term in ship at high temperature and high humidity, hence such deterioration was a significant obstruction for stabilizing the quality.

The purpose of the invention is to provide a package and method of preserving said solid material that solve the problem aforementioned.

### DISCLOSURE OF THE INVENTION

The invention relates to a package of solid material of carboxylic anhydride-modified chlorinated polyolefin, wherein said solid material is wrapped with a film with the value of water vapor transmission rate measured according to ASTM D895 of 1.5 g/m²·24 hr or lower.

Furthermore, the invention relates to a method of preserving said solid material that allows to stabilize the quality without moisture sorption upon storing and preserving said solid material.

The carboxylic anhydride-modified chlorinated polyolefin concerned in the invention can be produced easily by the publicly known methods. For example, as the methods of graft polymerizing unsaturated carboxylic acid monomers of carboxylic anhydrides such as maleic anhydride and itaconic anhydride onto polyolefin, 1) unsaturated carboxylic acid monomer is added to molten polyolefin resin, employing reactor, Banbury mixer, kneader, extruder, etc., to conduct the polymerization reaction in the presence of radical generator, 2) polyolefin resin is dissolved into solvents such as toluene and xylene under heating and unsaturated carboxylic acid monomer is added to conduct the polymerization reaction in the presence of radical generator, and the like are known. Moreover, to these carboxylic anhydride-modified chlorinated polyolefins, stabilizers that use compounds with epoxy group, etc. are added usually.

Besides, the polyolefin resin that becomes raw material is not particularly restricted, if it is one used usually. If need be, it is offered after viscosity reduction or degradation by heat decomposition.

The chlorination of polyolefin graft copolymerized with carboxylic anhydride can be achieved by dissolving it into a solvent such as carbon tetrachloride or chloroform and blowing-in chlorine gas within a temperature range from 50 to 120° C. under applied pressure or ambient pressure in the presence of radical-generating catalyst or under irradiation of ultraviolet rays to-react.

Moreover, it can also be obtained by chlorinating a terpolymer copolymerized unsaturated carboxylic acid monomer, unsaturated vinyl ester monomer and ethylene by publicly known methods such as high-pressure radical polymerization process, solution polymerization process and emulsion polymerization process, by the method as described above.

Besides, the grafting rate of carboxylic anhydride and the chlorine content of carboxylic anhydride-modified chlorinated polyolefin are not particularly restricted.

The solidification of carboxylic anhydride-modified chlorinated polyolefin can be accomplished by distilling-off the solvent for chlorinating reaction such as carbon tetrachloride or chloroform under reduced pressure after completion of the chlorinating reaction to obtain concentrated reaction liquor, by adding stabilizer thereto and then by drying with drum dryer. Moreover, it can also be accomplished by completely removing the reaction solvent with extruder with vent port installed for distilling-off the reaction solvent under reduced pressure in place of drum dryer, by extruding the solid material of chlorinated polyolefin composition in the shape of strand and by pelletizing with cutter under water or water-cooling type pelletizer. In the invention, the solid material means one with remaining solvent level of 3% by weight or lower.

The film to be used in the invention is required to have the value of water vapor transmission rate measured according to ASTM D895 (“Standard Test Method Water Vapor Permeability of Packages”) (measuring conditions: temperature 37.8±1.1° C., relative humidity 90±2%) of 1.5 g/m²·24 hr or lower. If exceeding 1.5 g/m²·24 hr, then the solid material of carboxylic anhydride-modified chlorinated polyolefin becomes unpreferable in a point that it absorbs moisture and the carboxylic anhydride causes ring opening over the time, resulting in increased solution viscosity and further decreased gasohol resistance.

The film to be used in the invention is produced from films of polypropylene (hereinafter referred to as PP), high-density polyethylene (hereinafter referred to as HDPE), low-density polyethylene (hereinafter referred to as LDPE), straight chain low-density polyethylene (hereinafter referred to as LLDPE), polyamide (hereinafter referred to as PA), poly(ethylene terephthalate) (hereinafter referred to as PET) and aluminum foil (hereinafter referred to as Al), paper, etc. Industrially, it is preferable to use as a composite film by compositing these. Also, multiply packaging with these films can be used, making the water vapor transmission rate 1.5 g/m²·24 hr or lower.

Preferable one among these composite films is a composite film with Al placed at center and other plastic films disposed on both sides. Moreover, since the film is closed tightly by heat seal, it is preferable to use polyethylenic film such as LLDPE or LDPE for inside film.

For the film of the invention, one produced by any method such as coating process, lamination process or coextrusion process can be used.

The package of solid material of carboxylic anhydride-modified chlorinated polyolefin in the invention indicates one with said solid material wrapped with the film aforementioned. It is only necessary that the whole of said solid material is wrapped with said film, and the packaging form of film is not particularly restricted. Industrially, bag form is preferable, but even box form is unproblematic. Moreover, it is preferable for putting the invention into practice to replace the inside of package with dried air with the moisture removed or inert gas such as nitrogen, or to install a dryer such as anhydrous calcium chloride or drying silica gel in said package body.

Best Embodiment to put the Invention into Practice

In the invention, the mechanism that the viscosity of carboxylic anhydride-modified chlorinated polyolefin is affected by moisture is presumed due to following reaction.

(Chemical Formula 1)

Reaction Between Maleic Anhydride-Modified Chlorinated Polyolefin and Water

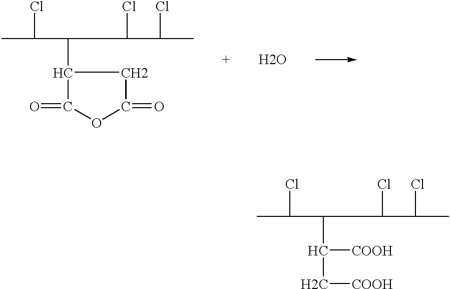

(Maleic Anhydride-Modified Chlorinated Polyolefin)

(Chemical Formula 2)

Reaction between maleic anhydride-modified chlorinated polyolefin, epoxy compound and water (formation of half ester)

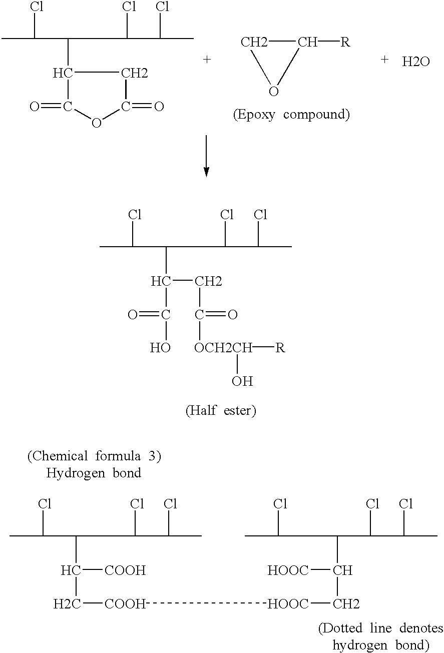

Namely, as in Chemical formula 1 and Chemical formula 2, by reacting maleic anhydride-modified chlorinated polyolefin with moisture in atmosphere or epoxy compound being a stabilizer, the carboxylic anhydride causes ring opening to produce carboxylic acid. If carboxylic acid is produced, then hydrogen bond is formed between molecules as in Chemical formula 3, thereby increasing the viscosity of solution over the time.

In the invention, the moisture in atmosphere is intercepted by using particular film and the ring-opening reaction of carboxylic anhydride is suppressed to make the production of carboxylic acid difficult, hence it becomes possible not to cause the viscosity increase due to hydrogen bond and to constantly keep the solution viscosity.

Moreover, although the mechanism that the gasohol resistance of carboxylic anhydride-modified chlorinated polyolefin is stabilized according to the invention is not clear, it is considered that the state of acid anhydride acts more advantageously on the miscibility and adherence. It is considered therefore that the film used in the invention intercepts the water in atmosphere, suppresses the ring-opening reaction of maleic anhydride and makes the production of carboxylic acid difficult, thereby the adherence between primer comprising carboxylic anhydride-modified chlorinated polyolefin and upper paint is maintained and the gasohol resistance is stabilized.

### EXAMPLE

In following, the invention will be illustrated concretely based on examples, but the invention is not confined thereto.

### Producing Example 1

In a three-neck flask attached with stirrer, dropping funnel and cooling pipe for refluxing monomer, 5 kg of crystalline polypropylene with weight average molecular weight of 50,000 were placed and molten completely in an oil bath kept constantly at 180° C. After nitrogen replacement in flask was performed for about 10 minutes, 200 g of maleic anhydride were put over about 5 minutes while stirring, and then a solution dissolved 20 g of di-tert-butyl peroxide into 50 ml of heptane was put over about 30 minutes from dropping funnel. At this time, the inside of system was kept at 180° C. After continued the reaction further for 1 hour, unreacted maleic anhydride was removed over about 30 minutes while reducing the pressure in flask with aspirator.

Next, 3 kg of this product were put in a glass-lined reactor, 50L of chloroform were added, and, after dissolved sufficiently at a temperature of 110° C. under a pressure of 3 kg/cm^{2,} chlorine gas was blown-in from the bottom of reactor while irradiating ultraviolet rays to conduct the chlorinating reaction. After reacted to target degree of chlorination, chloroform being a reaction solvent was concentrated with evaporator under reduced pressure, and tert-butylphenyl glycidyl ether was added in amount of 4% by weight based on solids as a stabilizer. Then this was dried up under reduced pressure and further vacuum drying was performed to obtain solid material of maleic anhydride-modified chlorinated polypropylene with amount of maleic anhydride of 2.4% by weight and chlorine content of 22% by weight.

### Producing Example 2

In a three-neck flask attached with stirrer, dropping funnel and cooling pipe for refluxing monomer, 3 kg of crystalline polypropylene with weight average molecular weight of 40,000, 180 g of maleic anhydride, 12 g of di-tert-butyl peroxide and 3 kg of xylene were placed, and, after nitrogen replacement in flask was performed for about 10 minutes, the reaction was conducted for 3 hours while stirring in an oil bath kept constantly at 140° C. After completion of the reaction, the reaction liquor was put in a large quantity of methyl ethyl ketone to deposit the resin. This resin was further washed with methyl ethyl ketone to remove the unreacted maleic anhydride.

Next, 2 kg of this product were put in a glass-lined reactor, 30L of chloroform were added, and, after dissolved sufficiently at a temperature of 110° C. under a pressure of 3 kg/cm^{2,} chlorine gas was blown-in from the bottom of reactor while irradiating ultraviolet rays to conduct the chlorinating reaction. After reacted to target degree of chlorination, chloroform being a reaction solvent was concentrated with evaporator under reduced pressure, and tert-butylphenyl glycidyl ether was added in amount of 4% by weight based on solids as a stabilizer. Then the solvent in this concentrated liquor was removed completely with extruder with vent port and the resulting product was pelletized with water-cooling type pelletizer to obtain solid material of maleic anhydride-modified chlorinated polypropylene with amount of maleic anhydride of 3.2% by weight and chlorine content of 20% by weight.

[Packages 1 Through 6

With combinations shown in Table 1, each 50 g of solid materials of maleic anhydride-modified chlorinated polypropylenes obtained in producing examples were packed and tightly closed by heat seal to fabricate packages. The physical properties of composite films are shown in Table 2.

(Table 1)

TABLE 1

| | Solid material of | |
|---|---|---|
| | maleicanhydride-modified | Composite |
| | chlorinated polypropylene | film |
| Package 1 | Producing example 1 | I |
| Package 2 | Producing example 2 | I |
| Package 3 | Producing example 1 | II |
| Package 4 | Producing example 2 | II |
| Package 5 | Producing example 1 | III |
| Package 6 | Producing example 2 | III |

(Table 2)

TABLE 2

| | | Thickness | Water vapor |
|---|---|---|---|
| | | of substrate | transmission |
| | Constitution of substrate | film | rate |
| Film | film | (μm) | (g/m² · 24 hr) |
| I | PET/Al foil/PA/PE/LLDPE | 12/9/25/20/60 | 1.3 |
| II | LLDPE/HDPE/LLDPE | 12/15/100 | 2.0 |
| III | Al-metallized PET/PA/LLDPE | 12/15/100 | 1.9 |

Film I: Trade name AL Pouch, From Okura Industrial Co., Ltd.
Film II: Trade name Schulpen, From Ube Film, Ltd.
Film III: Trade name Takenoko Bag, From Okura Industrial Co., Ltd.

### Example 1

### Determination of Degree of Ring Opening]

Packages 1 through 6 were placed statically in a desiccator with water on the bottom and cap of desiccator was closed completely and tightly, which was allowed to stand for 1 week in an atmosphere of 40° C. At this time, the relative humidity in desiccator was about 90% RH. After a week, said packages were taken out from desiccator, each of the solid materials of maleic anhydride-modified chlorinated polypropylenes was dissolved into toluene and coated on a KBr plate. After toluene was removed sufficiently, infrared spectrum was taken with infrared spectrophotometer. Besides, the infrared spectra of solid materials before placing in desiccator were made to be blanks.

The degree of ring opening of maleic anhydride was determined from following formula. Namely, if measuring the absorbances of absorption originating from maleic anhydride (1780 cm⁻¹) and absorption originating from —CH₃ (1460 cm⁻¹), then the relative amount of maleic anhydride can be seen from the ratio (FGI) thereof. Using this FGI, the degree of ring opening was calculated from the reduction rate against blank. It is shown that the higher the numerical value of degree of ring opening, the more the advance in ring opening of maleic anhydride. The measuring results are shown in Table 3.

Degree of ring opening of maleic anhydride(%)=(FGI_{blank}−FGI)/FGI_{blank}×100

FGI=(Absorbance at 1780 cm⁻¹)/(Absorbance at 1460 cm⁻¹) (Formula 1)

(Table 3)

TABLE 3
Degree of ring opening of maleic
anhydride in solid material

| | Degree of ring opening (%) |
|---|---|
| Blank 1 | 0 |
| (Solid material in Producing | |
| example 1) | |
| Package 1 | 7.6 |
| Package 3 | 54.7 |
| Package 5 | 52.9 |
| Blank 2 | 0 |
| (Solid material in Producing | |
| example 2) | |
| Package 2 | 12.5 |
| Package 4 | 62.5 |
| Package 6 | 60.0 |

From Table 3, maleic anhydride in solid materials of maleic anhydride-modified chlorinated polypropylenes in packages 1 and 2 packed with composite film I with water vapor transmission rate of 1.5 g/m²·24 hr or lower causes little ring opening, whereas, with packages 3 through 6 used composite films. II and III with water vapor transmission rate exceeding 1.5 g/m²·24 hr, the greater part of maleic anhydride in said solid materials causes the ring opening reaction with moisture, resulting in transmutation.

### Example 2

### Measurement of Viscosity

After packages 1, 3 and 5 were placed statically for 3 months and 6 months in an atmosphere of temperature of 20° C. and humidity of 65%, each interior solid material of maleic anhydride-modified chlorinated polypropylene was dissolved into a mixed solvent of toluene/cyclohexane=70/30 (wt./wt.), and, after concentration was adjusted to 20% by weight, the solution viscosity was measured using Brookfield type viscometer. Besides, the solution viscosity of said solid material before placing statically was measured similarly, which was made to be blank. The measuring results are shown in Table 4.

(Table 4)

TABLE 4

| | Solution viscosity (mPa · s/25° C.) | |
|---|---|---|
| | After placing statically | After placing statically |
| | for 3 months | for 6 months |
| Package 1 | 68 | 73 |
| Package 3 | 230 | 970 |
| Package 5 | 220 | 940 |

| | |
|---|---|
| Blank | 66 (before placing statically) |

From Table 4, the solution viscosity of solid material of maleic anhydride-modified chlorinated polypropylene in package 1 packed with composite film I with water vapor transmission rate of 1.5 g/m² 24 hr or lower changes little even after preserved for a long time, whereas, with packages 3 and 5 used composite films II and III with water vapor transmission rate exceeding 1.5 g/m² 24 hr, the solution viscosities increase remark-ably after preserved for a long term.

### Example 3

### Test of Gasohol Resistance

Packages 2, 4 and 6 were allowed to stand in a desiccator for a week similarly to Example 1 and each interior solid material of maleic anhydride-modified chlorinated polypropylene was dissolved into toluene at a concentration of 10% by weight to fabricate a primer. Next, this primer was spray painted or coated with Meyer bar onto a polypropylene plate washed with water, so as the film thickness to become 10 μm. After several minutes, a two-component cure type urethane paint was spray painted so as to become 30 to 40 μm, dried for about 15 minutes at room temperature, and then dried forcedly for 30 minutes at 80° C. After allowed to stand statically for 3 days at room temperature, test of gasohol resistance was performed.

The test of gasohol resistance was made by soaking the painted plate with both ends cut into a mixed gasoline of regular gasoline:ethanol=9:1 and by judging the time until the coated surface peeled off by around 2 mm from cut ends. Besides, the primer used the solid material before allowed to stand was made to be blank. The measuring results are shown in Table 5.

(Table 5)

TABLE 5
Test results of Gasohol resistance

| | Gasohol resistance (min)* |
|---|---|
| Blank | >60 |
| Package 2 | >60 |
| Package 4 | 25 |
| Package 6 | 28 |

Gasohol resistance (min)* Passing is 60 or more.

From Table 5, the gasohol resistance of solid material of maleic anhydride-modified chlorinated polypropylene in package 2 packed with composite film I with water vapor transmission rate of 1.5 g/m²·24 hr or lower changes little compared with blank, whereas, with packages 4 and 6 used composite films II and III with water vapor transmission rate exceeding 1.5 g/m²·24 hr, the gasohol resistances after allowed to stand for a week decrease remarkably.

### UTILIZABILITY IN THE INDUSTRY

In accordance with the invention, the problem of the changes in physical properties of solid material of carboxylic anhydride-modified chlorinated polyolefin on preserving for a long term, which was problematic so far, could be solved.

Namely, the invention exerts an effect that the ring opening of carboxylic anhydride in said solid material due to water is suppressed, thus making it possible to suppress increased viscosity and decreased gasohol resistance.

Since the quality of said solid material can be maintained stably for a long term according to the invention, it is very useful on exporting or keeping for a long term.

1. A package of solid material of carboxylic anhydride-modified chlorinated polyolefin, comprising said solid material of carboxylic anhydride-modified chlorinated polyolefin wrapped with a film with the value of water vapor transmission rate measured according to ASTM D895 of 1.5 g/m²·24 hr or lower.

2. A method of preserving solid material of carboxylic anhydride-modified chlorinated polyolefin, characterized by wrapping said solid material of carboxylic anhydride-modified chlorinated polyolefin with a film with the value of water vapor transmission rate measured according to ASTM D895 of 1.5 g/m²·24 hr or lower.
